(19) United States
(12) Patent Application Publication
(10) Pub. No.: US 2010/0257514 A1
(43) Pub. Date: Oct. 7, 2010

(54) EFFECTIVE MAPPING OF CODE SECTIONS TO THE SAME SECTION OF SECONDARY MEMORY TO IMPROVE THE SECURITY OF COMPUTING SYSTEMS

(75) Inventors: Onur Aciicmez, San Jose, CA (US); Xinwen Zhang, San Jose, CA (US); Jean-Pierre Seifert, Tirol (AT)

Correspondence Address: Beyer Law Group LLP/ SISA, P.O. Box 1687, Cupertino, CA, 95015-1687, US

(73) Assignee: SAMSUNG ELECTRONICS CO., LTD., Suwon City (KR)

(21) Appl. No.: 12/417,999

(22) Filed: Apr. 3, 2009

(51) Int. Cl. G06F 9/45; G06F 12/00

(52) U.S. Cl. 717/136; 711/123

(57) ABSTRACT

Executable computer code sections can be stored in the same section of secondary memory (e.g., instruction cache) during execution time in order to reduce the observable changes to the state of the secondary memory, thereby enhancing the security of computing systems that use secondary memory in addition the primary (main) memory to support execution of computer code. In addition, size of code sections can also be effectively adjusted so that code sections that are mapped to the same section of the secondary memory appear to have the same size, thereby further reducing the observable changes to the state of the secondary memory. As a result, the security of computing system can be further enhanced. It should be noted that code sections can be effectively relocated to cause them to map to the same section of secondary memory. It will be appreciated that mapping code sections considered to be critical to security can be especially useful to improving security. For example, codes sections considered to be critical to security can be identified and effectively mapped to the same section of an instruction cache (I-cache) as provided in more modern computing systems in order to improve the efficiency of execution, thereby allowing use of the I-cache in a more secure manner.

### BACKGROUND OF THE INVENTION

Conceptually, a computing system (e.g., a computing device, a personal computer, a laptop, a Smartphone, a mobile phone) can accept information (content or data) and manipulate it to obtain or determine a result based on a sequence of instructions (or a computer program) that effectively describes how to process the information. Typically, the information is stored in a computer readable medium in a binary form. More complex computing systems can store content including the computer program itself. A computer program may be invariable and/or built into, for example a computer (or computing) device as logic circuitry provided on microprocessors or computer chips. Today, general purpose computers can have both kinds of programming. A computing system can also have a support system which, among other things, manages various resources (e.g., memory, peripheral devices) and services (e.g., basic functions such as opening files) and allows the resources to be shared among multiple programs. One such support system is generally known as an Operating System (OS) which provides programmers with an interface used to access these resources and services.

Today, numerous types of computing devices are available. These computing devices widely range with respect to size, cost, amount of storage and processing power. The computing devices that are available today include: expensive and powerful servers, relatively cheaper Personal Computers (PC's) and laptops and yet less expensive microprocessors (or computer chips) provided in storage devices, automobiles, and household electronic appliances.

In recent years, computing systems have become more portable and mobile. As a result, various mobile and handheld devices have been made available. By way of example, wireless phones, media players, Personal Digital Assistants (PDA's) are widely used today. Generally, a mobile or a handheld device (also known as handheld computer or simply handheld) can be a pocket-sized computing device, typically utilizing a small visual display screen for user output and a miniaturized keyboard for user input. In the case of a Personal Digital Assistant (PDA), the input and output can be combined into a touch-screen interface.

A Central Processing Unit (CPU) cache is a cache that can be used to reduce the average time it takes the CPU to access memory. A CPU cache can be smaller but faster memory storing copies of data from the most frequently used main memory locations. If most memory accesses are cached memory locations, the average latency of memory accesses will be closer to the cache latency rather than to the latency of main memory. When the processor needs to read from or write to a location in main memory, it can first determine whether a copy of that data is in the cache. If so, the processor can immediately read from or write to the CPU cache, which can be much faster than reading from or writing to main memory.

Today, computing systems (e.g., modern desktop and server) can have CPUs with at least three independent caches: an instruction cache (I-cache) to speed up fetching executable instructions, a data cache (D-cache) to speed up data fetch and store, and a translation lookaside buffer used to speed up virtual-to-physical address translation for both executable instructions and data.

The popularity of computing systems is evidenced by their ever increasing use in everyday life. Accordingly, techniques that can further improve computing systems would be very useful.

### SUMMARY OF THE INVENTION

Broadly speaking, the invention relates to computing environments and/or computing systems. Generally, the invention relates to computing identify systems and computing environments. More particularly, the invention pertains to improved techniques for storing code sections in secondary memory.

In accordance with one aspect of the invention, data that effectively identifies executable computing code sections to be mapped to the same section of secondary memory (“secondary-memory-mapping data”) can be generated. As a result, the observable state changes of the secondary memory can be reduced. In one embodiment, computer program code is obtained in order to generate secondary-memory-mapping data that effectively identifies at least first and second executable computer code sections of the computer program code as sections to be mapped to the same section of the secondary memory. It should be noted that the secondary-memory-mapping data can be stored in a computer readable storage medium. It should also be noted that the secondary-memory-mapping data can be effectively integrated with executable computer code generated for the computer program code. By way of example, a compiler can be operable to generate executable code that includes secondary-memory-mapping data identifying executable computer code sections to be mapped to the same section of the secondary memory, as will be appreciated by those skilled in the art.

In accordance with another aspect of the invention, executable computer code sections of executable computer code are mapped to the same section of the secondary memory during execution time of the executable computer code. In one embodiment, at least first and a second executable computer code sections of a plurality of executable computer code sections are identified as sections to be mapped to the same section of the secondary memory and are mapped to the same section of the secondary memory accordingly. It should be noted that the code sections can, for example, be identified based on data provided by and/or effectively integrated with the executable computer code.

It will be appreciated that the size of code sections can be effectively adjusted so that code sections that are mapped to same section of the memory appear to have the same size, thereby making it even more difficult to observe changes to the state of the secondary cache. In addition, code sections can be effectively relocated to effectively cause them to map to the same section of secondary memory.

Those skilled in the art will also appreciate that the invention is especially suitable for enhancing the security of computing systems that use an instruction cache (I-cache). In particular, the invention allows selecting the sections of computer code considered to be important to security and possibly resizing and/or relocation them in order to map them to the same section of an I-cache. As a result, it would be difficult for a “spy” program to obtain information regarding the code sections by effectively observing the state changes of the I-cache.

The invention can be implemented in numerous ways, including, for example, a method, an apparatus, a computer readable (and/or storable) medium, and a computing system (e.g., a computing device). A computer readable medium can, for example, include at least executable computer program code stored in a tangible form. Several embodiments of the invention are discussed below.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1A depicts a computing system 100 in accordance with one embodiment of the invention.

FIG. 1B depicts a computing system in accordance with another embodiment of the invention.

FIG. 2A depicts a method for generating data for execution of executable computer code by a computing system in accordance with one embodiment of the invention.

FIG. 2B depicts a method for storing executable computer code in secondary memory in accordance with one embodiment of the invention.

FIG. 3A depicts conventional placement of code sections in an I-cache in accordance with one embodiment of the invention.

FIG. 3B depicts code sections placed in the same section of I-cache in accordance with one exemplary embodiment of the invention.

FIG. 4A depicts placements of code sections in primary memory and I-cache in accordance with conventional techniques.

FIG. 4B depicts the placement of code sections in primary memory and I-cache in accordance with one exemplary embodiment of the invention.

FIG. 5 depicts an Executable and Linking Format (or ELF) file in accordance with one embodiment of the invention.

FIG. 6 depicts an exemplary “process descriptor” in accordance with one embodiment of the invention.

### DETAILED DESCRIPTION OF THE INVENTION

As noted in the background section, a CPU (or a microprocessor) can use an instruction cache (I-cache) to effectively improve the performance of a computing system. An Instruction cache (I-cache) can store most frequently executed instructions and allow a CPU to access them faster than accessing them from the main memory. While increasing the performance of the system, an I-cache can introduce security issues. One issue is that changes (or state changes) of the I-cache can be observed during the execution of a computer program in order to obtain sensitive information pertaining to the computer program. By way of example, an adversary component can execute “spy” code/process that keeps track of the changes in the state of an I-cache (e.g., changes to metadata during the execution of a cipher process). The spy code/process can run simultaneously or quasi-parallel with the cipher process and determine which instructions are executed by the cipher and thereby learn sensitive information, for example, including, secret keys (e.g., RSA keys).

More generally, conventional use of secondary memory (e.g., an I-cache, D-cache) provided for execution of computer code can compromise security. Accordingly, techniques that allow use of secondary memory in a more secure manner are needed and would be very useful.

The invention relates to computing systems and computing environments. More particularly, the invention pertains to improved techniques for storing code sections in secondary memory.

In accordance with one aspect of the invention, data that effectively identifies executable computing code sections to be mapped to the same section of secondary memory (“secondary-memory-mapping data”) can be generated. As a result, the observable state changes of the secondary memory can be reduced. In one embodiment, computer program code is obtained in order to generate secondary-memory-mapping data that effectively identifies at least first and second executable computer code sections of the computer program code as sections to be mapped to the same section of the secondary memory. It should be noted that the secondary-memory-mapping data can be stored in a computer readable storage medium. It should also be noted that the secondary-memory-mapping data can be effectively integrated with executable computer code generated for the computer program code. By way of example, a compiler can be operable to generate executable code that includes secondary-memory-mapping data identifying executable computer code sections to be mapped to the same section of the secondary memory, as will be appreciated by those skilled in the art.

In accordance with another aspect of the invention, executable computer code sections of executable computer code are mapped to the same section of the secondary memory during execution time of the executable computer code. In one embodiment, at least first and a second executable computer code sections of a plurality of executable computer code sections are identified as sections to be mapped to the same section of the secondary memory and are mapped to the same section of the secondary memory accordingly. It should be noted that the code sections can, for example, be identified based on data provided by and/or effectively integrated with the executable computer code.

It will be appreciated that the size of code sections can be effectively adjusted so that code sections that are mapped to same section of the memory appear to have the same size, thereby making it even more difficult to observe changes to the state of the secondary cache. In addition, code sections can be effectively relocated to effectively cause them to map to the same section of secondary memory.

Those skilled in the art will also appreciate that the invention is especially suitable for enhancing the security of computing systems that use an instruction cache (I-cache). In particular, the invention allows selecting the sections of computer code considered to be important to security and possibly resizing and/or relocation them in order to map them to the same section of an I-cache. As a result, it would be difficult for a “spy” program to obtain information regarding the code sections by effectively observing the state changes of the I-cache.

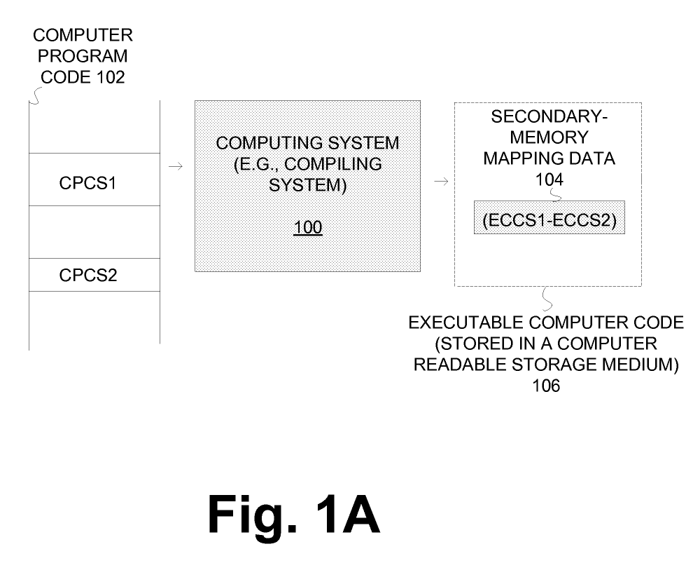

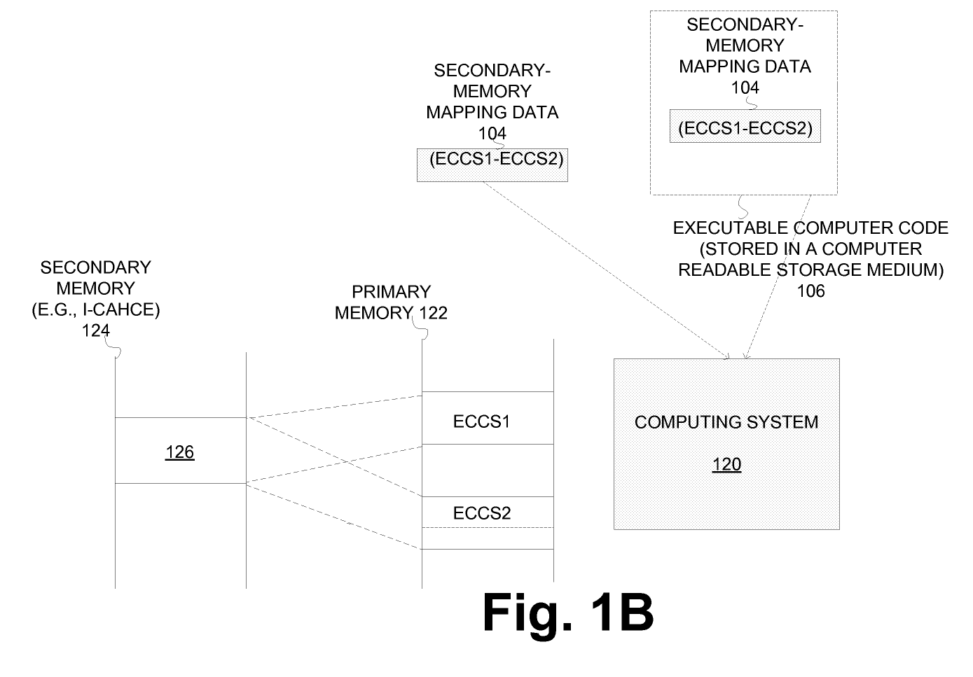

Embodiments of these aspects of the invention are discussed below with reference to FIGS. 1A-6. However, those skilled in the art will readily appreciate that the detailed description given herein with respect to these figures is for explanatory purposes as the invention extends beyond these limited embodiments.

FIG. 1A depicts a computing system 100 in accordance with one embodiment of the invention. It will be appreciated that the computing system 100 can, for example, be provided as various computing devices (e.g., a personal computer (pc), a mobile and/or smart phone, a server). Those skilled in the art will readily appreciate that the computing system 100 can, for example, include one or more processors operable to execute executable computer code and memory operable to store computer program code (not shown).

Referring to FIG. 1A, the computing system 100 can be operable to obtain computer program code (CPC) 102 including a plurality of computer programs code sections (CPCS1 and CPCS2). As will be known to those skilled in the art, the computer program code (CPC) 102 can, for example, be source code written in a high-level computer programming language (e.g., source code written in C, C++, or Java programming language).

The computing system 100 can also be operable to effectively identify at least first and second computer program code sections (CPCS1 and CPCS2) as a sections to be mapped to do same section of secondary memory that can be provided for (or in addition to) primary memory operable to store an executable version of computer program code 102. As such, secondary memory can effectively support execution of the executable version of the computer program code 102 and may be provided, for example, as cache memory to effectively improve execution time and computing. Secondary memory can be operable to provide relatively faster access time than primary memory but may be smaller than primary memory. By way of example, secondary memory can be provided as an instruction cache (or an “I-cache,” as generally known in the art).

It will be appreciated that computer program code sections can be mapped to the same section of secondary memory for a variety of reasons. In particular, effectively mapping executable computer code sections to the same section of secondary memory could improve security especially with respect to sections that may be considered to be “important” and/or “critical” to security (e.g., code sections that may contain or may be associated with security keys, encryption keys, passwords, and so on). Generally, mapping the sections to the same section of the secondary memory would help to mask differences or changes with respect to the state of the secondary memory that may be observed by external and/or unauthorized components (e.g., spyware programs, monitoring (or logging) programs).

Those skilled in the art will appreciate that first and second computer program code sections (CPCS1 and CPCS2) may, for example, be identified by a programmer and/or developer as program code sections to mapped to do same section of secondary memory. In other words, a programmer or developer of the computer program code (CPC) 102 may effectively identify (or mark) first and second computer program code sections (CPCS1 and CPCS2) as sections to be mapped to do same section of secondary memory.

Moreover, it will be appreciated that the computing system 100 can be operable to analyze computer program code 102 in order to identify the first and second computer program code sections (CPCS1 and CPCS2) as a sections to be mapped to do same section of secondary memory provided for a primary memory operable to store executable computer program code of the computer program code 102.

Generally, the computing system 100 can be operable to generate secondary-memory-mapping data 104 for the computer program code 102. The secondary-memory-mapping data 104 can effectively identify at least first and a second executable computer code sections (ECCS1 and ECCS2) as sections to be mapped to the same section of secondary memory. Those skilled in the art will also appreciate that the computing system 100 can be operable to store the secondary-memory-mapping data 104 to a computer readable storage medium (e.g., non-volatile memory, hard disk, Compact Disk (CD), volatile memory). Furthermore, the computing system 100 can be operable to generate executable computer program code 106 for the computer program code 102. As shown in FIG. 1A, secondary-memory-mapping data 104 may be effectively integrated into executable computer program code 106 and provided in a computer readable storage medium. Those skilled in the art will appreciate that the computing system 100 can, for example, be and/or include a compiler operable to generate executable computer code 106 for the computer program code 102. A complier can also be operable to analyze the computer program code 102 in order to effectively identify computer program code sections to be mapped to the same section of the secondary memory (e.g., CPCS1 and CPCS2).

As noted above, mapping executable code sections to the same section of the secondary memory could effectively mask differences or changes with respect to the state of the secondary memory that may be otherwise observable to unauthorized and/or adverse entities (e.g., spy programs). It should be noted that difference in size of two executable code sections may also result in changes in the state of secondary memory even though the executable code sections are mapped to the same section of secondary memory. Therefore, to provide additional security, the computing system 100 may also be operable to generate first and second executable computer codes (ECCS1 and ECCS2) respectfully corresponding to the first and second computer program code sections (CPS1 and CPS2) such that the first and second executable computer codes (ECCS1 and ECCS2) have the same size and/or have no observable differences with respect to their size. This means that the computing system 100 may be operable to effectively expand and/or deflate (or contract) the size of the actual executable computer codes (ECCS1 and ECCS2). Generally, it may be more feasible to expand the size of executable computer code. By way of example, no-operation and/or dummy instructions can be effectively added to increase the size of the first executable computer codes (ECCS1) so that it matches the size of the second executable computer codes (ECCS2). The no-operation and/or dummy instructions can, for example, be generated by a complier component of the computing system 100 (not shown).

In addition, the first and second executable computer codes (ECCS1 and ECCS2) can be effectively generated in locations of the executable computer code 106 (or relocated) to cause them to be mapped to do same section of secondary memory, provided that it is known at the time executable code is generated code (e.g., compile time) which portions of the executable computer code 106 would map to the same section of secondary memory during the execution time. By way of example, a compiler can be operable to effectively relocate first and/or second computer program codes (CPS1 and CPS2), if necessary, in order to cause the corresponding executable code sections to be mapped to the same section of secondary memory when the compiler generates executable code for a known target machine. Those skilled in the art will readily appreciate that executable computer code 106 can, for example, include an object code (or one or more object files), a binary code (one or more binary files), and/or data in an Executable and Linking Format (ELF).

Referring back to FIG. 1A, it should be noted that the secondary-memory-mapping data 104 can effectively identify first and second executable computer code sections (ECCS1 and ECCS2) as sections to be mapped to the same section of secondary memory, and consequently it can be used by a computing system at execution time to map first and second executable computer code sections (ECCS1 and ECCS2) to the same section of secondary memory.

To further elaborate, FIG. 1B depicts a computing system 120 in accordance with another embodiment of the invention. Similar to the computing system 100 depicted in FIG. 1A, it will be appreciated that the computing system 100 can, for example, be provided as various computing devices (e.g., a personal computer (pc), a mobile and/or smart phone, a server) and it can include one or more processors operable to execute executable computer code and memory operable to store executable computer code (not shown). Those skilled in the art will also appreciate that the computing system 120 (depicted in FIG. 1B) and computing system 100 (depicted in FIG. 1A) can be the same and/or effectively integrated and/or provided in the same computing system.

Generally, computing system 120 can be operable to obtain (e.g., receive, locate, generate, identify, determine) the secondary-memory-mapping data 104 associated with executable computer code 106 (shown in FIG. 1A). As noted above, the secondary-memory-mapping data 104 may, for example, be provided as a part of executable computer code 106. Typically, the computing system 120 is operable to store the executable computer code 106 in primary (or main) memory 122 when the computing system 120 is to execute the executable computer code 106. As will be known to those skilled in the art, memory 122 can be provided to effectively support the execution of the executable computer code 106 and may be referred to as primary memory. Secondary memory 124 can also be provided to effectively support execution of the executable computer code 106. As noted above, secondary memory, such as the secondary memory 124 (depicted in FIG. 1B), can function as a cache (e.g., an I-cache and/or a D-cache) for storing data and/or instructions pertaining to execution of the executable computer code 106.

Referring to FIG. 1B, computing system 120 can be operable to store the first and second executable computer code sections (ECCS1 and ECCS2) to the same section of the secondary memory 124, namely, section 126 of the secondary memory 124. It should be noted that the computing system 120 may also be operable, if necessary, to effectively relocate the first and/or second executable computer code sections (ECCS1 and/or ECCS2) in the primary 122 with respect to their original location in the executable computer code 106 in order to ensure that the executable sections map to the same section of the memory section 124. As noted above, relocation of code sections may be performed at compilation time when the information is available so it may not be necessary for the computing system 120 to relocate the first or second executable computer code sections (ECCS1 and/or ECCS2).

It should be noted that the size of the first and/or second executable computer code sections (ECCS1 and/or ECCS2) may be adjusted at compile time. Although it may be more feasible at least it some cases to effectively adjust the size of the first and/or second executable computer code sections (ECCS1 and/or ECCS2) at compile time when executable computer code 106 is generated, the computing system 120 may also be operable to adjust the size of first and/or second executable computer code sections (ECCS1 and/or ECCS2) by, for example, adding one or more no-operation and/or dummy instructions.

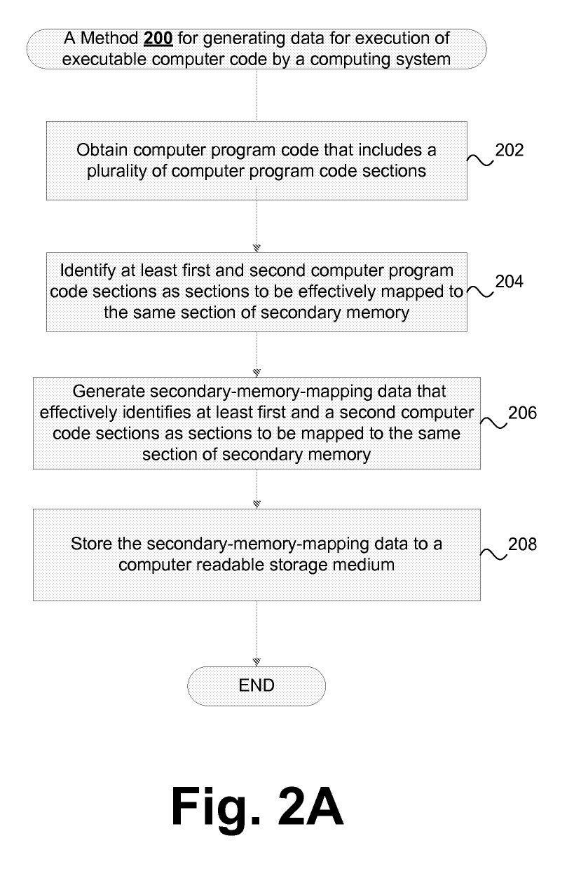

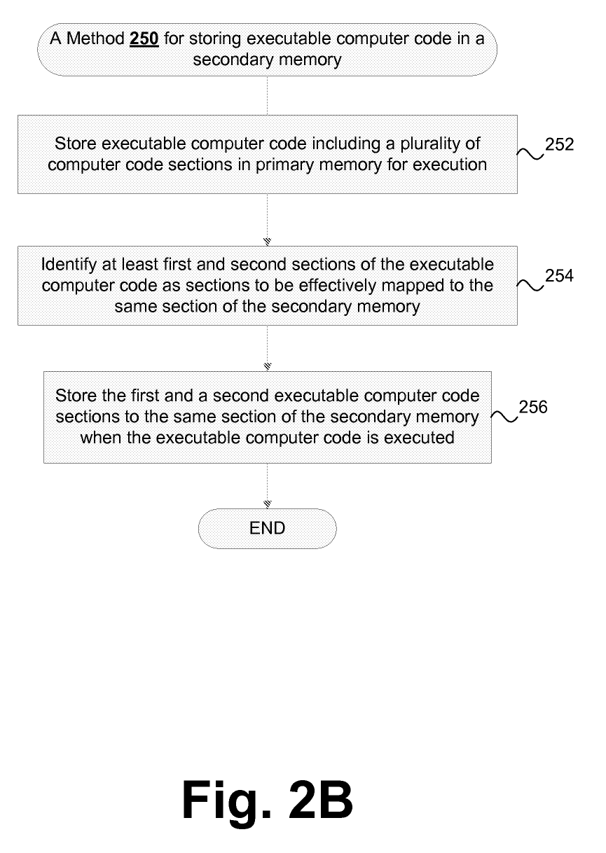

FIG. 2A depicts a method 200 for generating data for execution of executable computer code by a computing system in accordance with one embodiment of the invention. Method 200 can, for example, be used by the computing system 100 depicted in FIG. 1A. Referring to FIG. 2A, initially, computer program code that includes a plurality of computer program code sections in obtained (202). Next, at least first and second computer program code sections are identified (204) as sections to be effectively mapped to the same section of secondary memory. Thereafter, secondary-memory-mapping data that effectively identifies at least first and a second computer code sections as sections to be mapped to the same section of secondary memory is generated (206). It should be noted that the first and a second computer program code sections are to be effectively mapped to the same section of secondary memory when executable computer code for the first and a second computer program code sections is to be executed (i.e., the executable version of computer program code for the first and section sections are to be mapped to the same section of secondary memory when executed, or when the executable computer code including executable computer program code for the first and second computer program code sections is executed). Finally, secondary-memory-mapping data is stored (208) to a computer readable storage medium before the method 200 ends.

FIG. 2B depicts a method 250 for storing executable computer code in a secondary memory in accordance with one embodiment of the invention. Method 250 can, for example, be used by the computing system 120 depicted in FIG. 1B. Referring to FIG. 2B, initially, executable computer code including a plurality of computer code sections is stored (252) in primary memory for execution. Next, at least first and sections of the executable computer code are identified (254) as sections to be effectively mapped to the same section of secondary memory. Thereafter, first and second executable computer code sections are stored to the same section of the secondary memory when the executable computer code executed (i.e., during execution time). It should be noted that the secondary memory can include at least a plurality of discrete memory sections. In other words, the secondary memory can be effectively partitioned or considered to have a plurality of discrete memory sections and the first and second executable computer code section can be stored into the same discrete section of the secondary memory. By way of example, when the first executable code section is executed it can be stored (cached) in a first section of an instruction cache (I-cache). When the second executable code section is executed, it too can be written to the first section of the instruction cache (I-cache) to effectively overwrite or evict the first executable code section in part or entirely. Referring back to FIG. 2A, the method 250 ends after the first and second executable computer code sections are stored in the same section of the secondary memory. However, those skilled in the art will readily appreciate that various code sections can be stored in the same section of the secondary memory during execution time as needed.

As noted above, modern microprocessors can use an instruction cache (I-cache). An instruction cache can improve the execution time and consequently the overall performance of a computing system. More particularly, an I-cache can store the most frequently executed instructions and provide them to the processor in a more efficient manner than accessing them for the primary memory (e.g., Random Access Memory). Unfortunately, I-cache can also create security problems by allowing the status of the I-cache to be observed.

When a processor needs to read instructions from the main memory, it can first check the I-cache to see if the instructions are stored in the I-cache. If the instructions are in the I-cache (“cache hit”), the processor can obtain them from the I-cache instead of accessing the primary (or main) memory with significantly longer latency. Otherwise (“cache miss”), the instructions are read from the memory and a copy of them is stored in the I-cache. Typically, each “I-cache miss” causes accessing a higher level of memory (i.e., a higher level of cache when more than one level is provided or main memory) and may cause relatively more delays in execution.

By keeping track of the changes (or states) of the I-cache, it is possible to obtain information regarding the code being executed. For example, “spy” code/process can keep track of the changes to the state of I-cache (i.e., changes to metadata during the execution of a cipher process). The spy code/process can run simultaneously or quasi-parallel with the cipher process and determine which instructions are executed by the cipher.

Those skilled in the art will know that sliding windows exponentiation can generates a key dependent sequence of modular operations and “OpenSSL” can use different functions to compute modular multiplications and square operations (see “Yet Another MicroArchitectural Attack: Exploiting I-cache,” Proceedings of the 2007 ACM Workshop on Computer Security Architecture, pages 11-18, ACM Press, Fairfax, Va., USA, Nov. 2, 2007). As a result, an adversary can run a spy routine and evict either one of these functions. The adversary can determine the operation sequence (squaring/multiplication) of RSA. In an attack scenario of a “protected” crypto process executing RSA signing/decryption operations and an adversary executing a spy process simultaneously or quasi-parallel executing: the spy routine can, for example, (a) continuously execute a number of dummy instructions, and (b) measure the overall execution time of all of these instructions in such a way that these dummy instructions precisely maps to the same I-cache location with the instructions of multiplication function. In other words, the adversary can create a “conflict” between the instructions of the multiplication function and the spy routine. Because of this “conflict,” either the spy or multiplication instructions can be stored in I-cache at a given time. Therefore, when the cipher process executes the multiplication function, the instructions of the spy routine are “evicted” from I-cache. This “eviction” can be detected by the spy routine because when it re-executes its instructions the overall execution time will suffer from I-cache misses. Thus, the spy can determine when the multiplication function is executed. This information can directly reveal the operation sequence (multiplication/squaring) of RSA. For the square & multiply exponentiation algorithm this can reveal a secret key in its entirety whereas for sliding windows exponentiation the attacker may learn more than half of the exponent bit. Further details of I-cache analysis are described in “Yet Another MicroArchitectural Attack: Exploiting I-cache,” Proceedings of the 2007 ACM Workshop on Computer Security Architecture, pages 11-18, ACM Press, Fairfax, Va., USA, Nov. 2, 2007,” which is hereby incorporated by reference herein in its entirety an for all purposes.

To elaborate even further, a simplified exemplarily I-cache analysis using RSA will be described below. However, it should be noted that use of I-cache can pose a generic threat applicable to virtually any process, application, or algorithm, as will be appreciated by those skilled in the art.

Considering the pseudocode representative of a simplified template of some cryptographic operations such as RSA exponentiation:

```
for all bits of secret_key
  if(secret_key[i]=1)
    execute Code Section 1
  else
    execute Code Section 2
end for
```

where “secret_key[i]” denotes the ith bit of a variable secret key (secret_key).

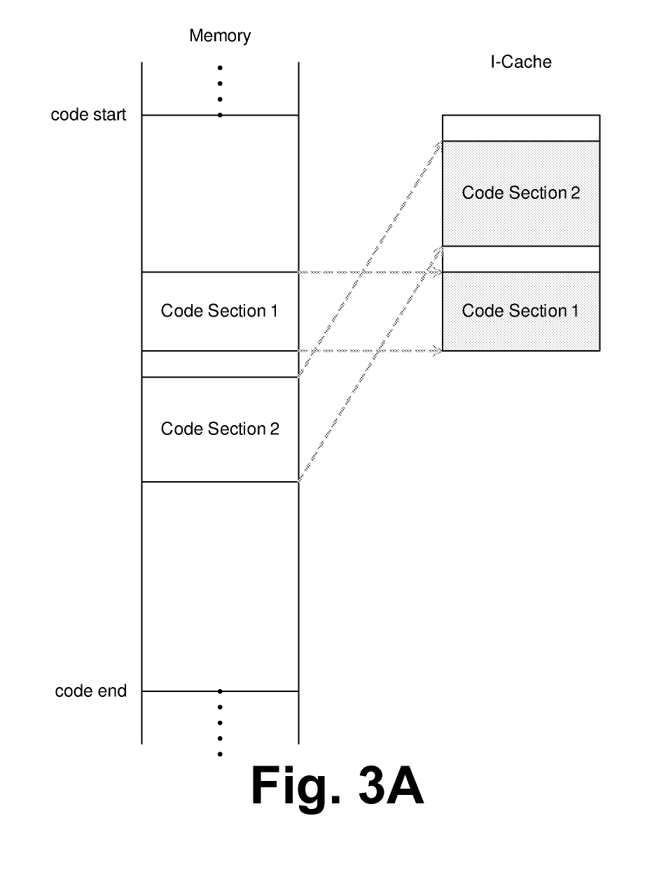

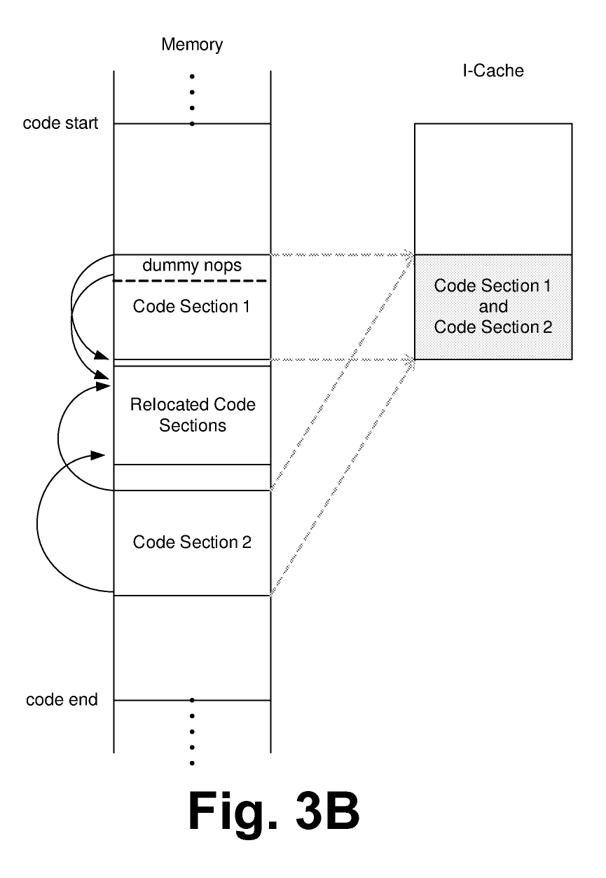

Referring now to FIG. 3A, assume that first and second Code Sections 1 and 2 (CS1 and CS2) as placed in the (final) executable code map to different regions of an I-cache. In this example, an I-cache spy (or attack) process can examine the I-cache states during the operation of the pseudocode noted above and may be able to determine when each one of the CS1 and CS2 are executed. This is due to the fact that first and second Code Sections 1 and 2 (CS1 and CS2) can map to different I-cache regions and their execution could affect different I-cache regions and thus resulting in “observable” differences in state of the I-cache.

In order to avoid observable differences in state of the I-cache, a compiler can be generally operable to effectively align executable computer code corresponding to first and second Code Sections 1 and 2 (CS1 and CS2) of the pseudocode noted above, as will be appreciated by those skilled in the art.

FIG. 3B depicts code sections placed in memory so that they map to the same section of I-cache. The placement may require one or more of the following operations:

a sequence of no-operation instructions (e.g., instructions that have no effect on execution) are appended in front of Code Section 1 to make its size the same size as CS2;
(a) CS2 is moved towards the end of the application code and relocated to a new place which maps to the same I-cache area as CS1;
(b) CS2 is moved towards the end of the application code and relocated to a new place which maps to the same I-cache area with CS1;
(c) The code that was residing in the new location of CS2 and the code that was residing in the location of the new part of CS1 are relocated; and

An I-cache may be attacked when key dependent variations in the flow of instructions map to different regions of the I-cache. However, if such instructions (e.g., multiplication and square operations in RSA/OpenSSL) are mapped exactly to the same section (or region) of I-cache, I-cache attacks cannot recover the operation sequence. If a compiler is given the I-cache parameters and the critical sections of a code, the compiler can generate programs more resistant to I-cache attacks (I-cache-attack -resistant programs) by appropriately aligning the sections considered to be “critical” code sections.

Generally, code sections can be identified to be mapped to the same section of the I-cache. These sections can, for example, be selected based on the security context of various computer codes. For example, if there is a control flow variation in a computer program that depends on a secret or sensitive data (such as the example noted above) then the sections can be considered to be sections critical to the security (or “critical sections”).

It should be noted that a “critical section” can be considered to have one or more counterparts. For example, code section CS1 and CS2 in the example above can be considered to be counterparts of each other and, as such, can be mapped to the same section of an I-cache. In addition, counterpart code sections can be made (or modified) to have or effectively exhibit the same code size. By way of example, in an “if-then-else statement,” the code sections (or blocks) immediately following the “if” and “else”, respectively, can be considered to be counterparts of each other. As another example, in an “if” statement without an “else” clause, the code that immediately follows the code block of the “if” statement can be considered to be the counterpart of the code block of the “if” statement. In a “switch” statement, there may be more several code blocks that are counterparts of each other, and so on.

To elaborate even further, consider an “if statement without an else” clause shown below:

```
for all bits of secret_key
  execute Code Section 1
  if(secret_key[i]=1)
    execute Code Section 2
  execute Code Section 3
end for
```

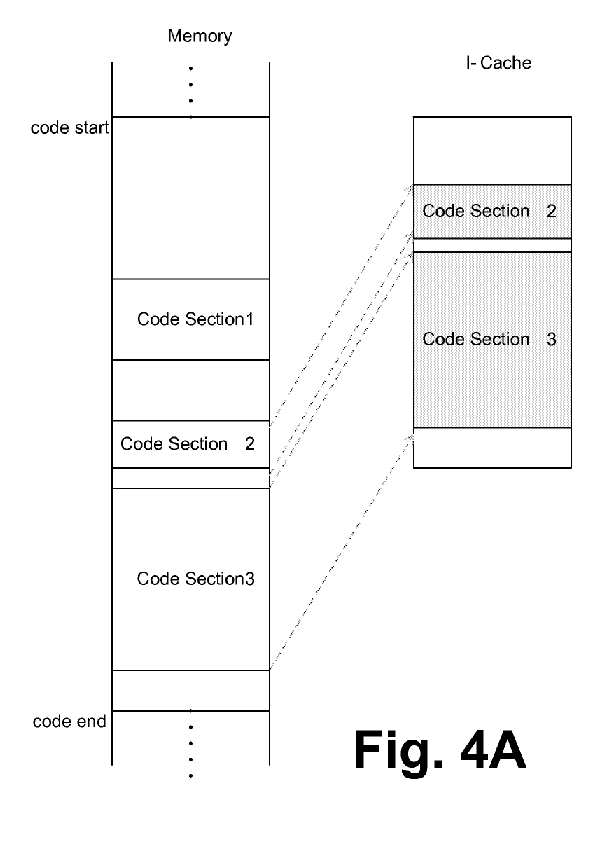

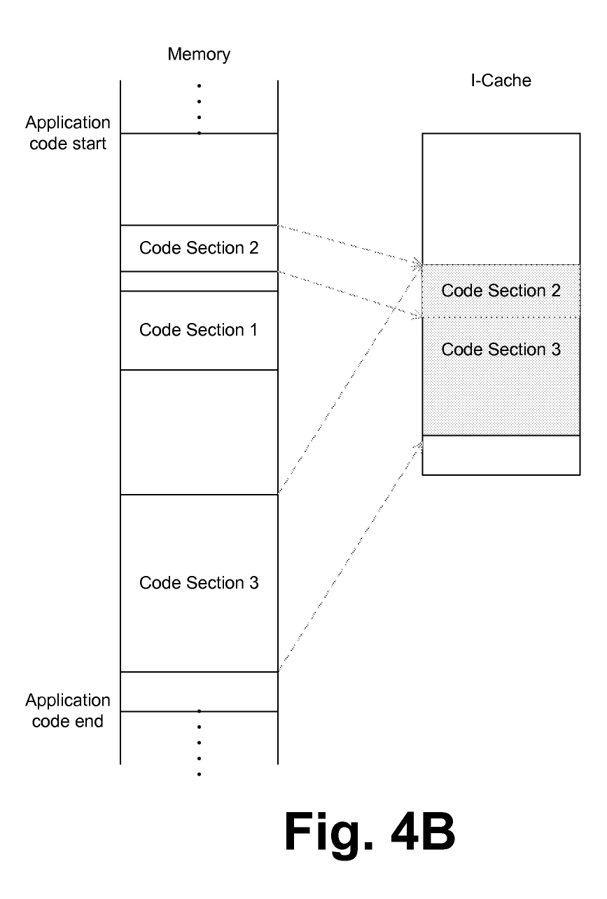

In this example, code sections 2 and 3 (CS2 and CS3) can be considered to be counterparts of each other, as will be appreciated by those skilled in the art. FIG. 4A depicts placements of code sections 1, 2 and 3 in the memory and I-cache in accordance with conventional techniques. On the other hand, FIG. 4B depicts the placement of code sections 1, 2 and 3 in the memory and I-cache in accordance with one exemplary embodiment of the invention.

Referring to FIG. 4A, it should be noted that code section 3 (CS3) is significantly larger than the code section 2 (CS2). No-operation or dummy instructions can be added to code section 2 (CS2) to make its size appear the same as the larger code section, namely, code section 3 (C3). It should be noted that if overhead of modifying the size of executable code (e.g., adding no-operation or dummy instructions) is a concern, a determination can be made as to whether the difference in size is significant enough to effectively cause an observable state change in the I-cache. Based on this decision, it can then be determined whether to modify the size.

As noted above, a compiler can be operable to effectively identify and/or select code sections to be mapped to the same section of the I-cache, as well as adding no-operation or dummy instructions and effectively relocating code to cause mapping them to the same section of the I-cache. However, to accomplish these tasks, a compiler may need more input that would be conventionally required. This addition input can include: data pertaining to the target I-cache (e.g., architectural details of the I-cache) and data pertaining to identification and/or selection of sections to be mapped to the same I-cache section (e.g., data identifying critical sections and/or counterpart sections).

It will be appreciated that the additional data, can, for example, be provided at the “build” time. By way of example, instead of the conventional command: “gcc-o program.exe program.c”, flags and/or additional command line arguments can be used:

gcc -enablelcachemitigation -cachesize=1MB -cachelinesize=64b -
associativity=4 -o program.exe program.c

As an alternative, the compiler can be operable to run benchmarks to detect parameters needed if the target machine is the same as the host.

As another alternative, critical sections and their counterparts can be identified manually, and effectively highlighted in the source code, for example, be using compiler specific preprocessing commands or flags. By way of example, the exemplary code noted above can be modified as shown below:

```
    for all bits of secret_key
      if(secret_key[i]=1)
#StartCriticalSection label1 part1
        execute Code Section 1
#EndCriticalSection label1 part1
      else
#StartCriticalSection label1 part2
        execute Code Section 2
#EndCriticalSection label1 part2
    end for
```

This would allow a compiler to effectively identify code sections 1 and 2 (CS1 and CS2) as critical code section and as counterparts of each other to be mapped to the same section of the I-cache. It should also be noted that a compiler can be operable to analyze the entire code or one or more sections of the code that have been effectively marked for analysis in order to detect critical code sections as counterparts. By way of example, code sections that show control flow variations based on a value (e.g., secret value) can be identified.

It should also be noted that an Operating System (OS) can be operable to perform the operations of effectively identifying and/or selecting code sections to be mapped to the same section of the I-cache, adding no-operation or dummy instructions, and effectively relocating code sections to cause them to be mapped to the same section of the I-cache. By way of example, a program file can have a table (e.g., a table in the header of the file) that identifies critical code sections as counterparts to be mapped to the same section of the I-cache. The Operating System (OS) can then place these counterpart sections in memory such that they map to the same I-cache region of a physically tagged cache, as will be appreciated by those skilled in the art. The Operating System (OS) can also be operable to add no-operation or dummy instructions.

Those skilled in the art will readily appreciate that a compiler can provide data, pertaining to computer code sections that are to be mapped to the same section of the I-cache, to an Operating System, for example, by providing the data in an object (or executable) file (e.g., an Executable and Linking Format (or ELF) object/program file). This data can indicate whether the object (or executable) file requires selective mapping and, if so, what sections of the code need to be selectively mapped to the I-cache.

By way of example, a new flag in “e_flags” structure in the ELF header can be provided. Alternatively, a new file type, i.e., a new value for “e_type” can be used to identify the executable code sections that are to be selectively mapped to the I-cache during execution time.

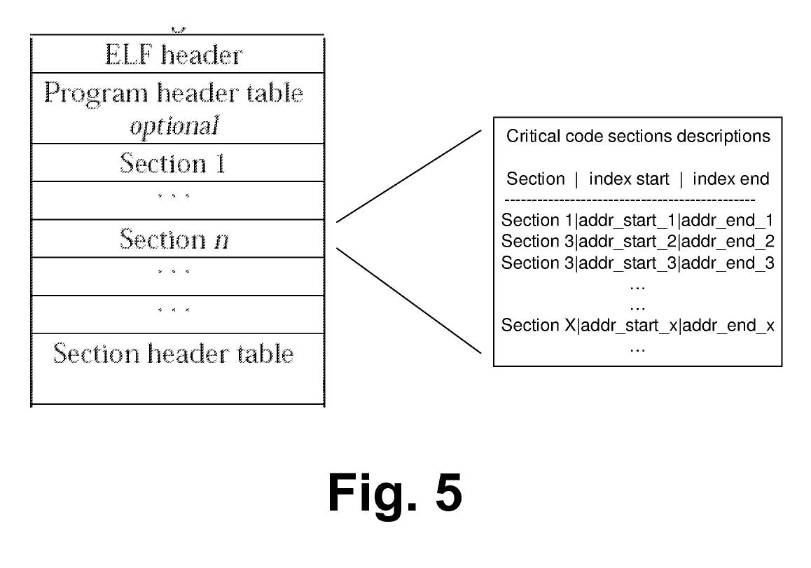

In addition, a special section type of “ELF” files, i.e., with a new value of “sh_type” can be defined. This ELF section can include the descriptions of the security critical code sections (SCCS) in other ELF sections in the same program/object file. To elaborate even further, FIG. 5 depicts an exemplary ELF file in accordance with one embodiment of the invention. Referring to FIG. 5, an “n” section of the ELF file can be a special section that holds the descriptions for security critical code sections (SCCS), namely security critical code sections 1 and 3. As shown in FIG. 5, the code for security critical code section can start from “addr_start_1,” which can be a virtual address relative to the start of a code section 1. The description for code section 3 can include two different security critical code sections (SCCS), and so on. Section “n” can also hold additional information, for example, counterpart information identifying critical code sections (SCCS) that are counterparts of each other.

As an alternative exemplary embodiment, each security critical code sections (SCCS) can be placed in a separate section of an Elf file. A section that has one or more critical code sections (SCCS) can be identified, for example, by using a new “sh_flags” value that indicates its status.

It should be noted that an Operating System (OS) can also store any information needed for effective management of selective mapping during execution time.

Taking the Linux Operating System as an example, when the Linux Operating System needs to initialize a program, it first modifies the process making a “execve( )” call, loads the program, resolves the symbols, and lets the process with the new program run. In accordance with one embodiment of the invention, an Operating System can check an executable file (e.g., an ELF file”) to determine whether to perform selective mapping of the I-cache for a particular program. By way of example, a Linux Operating System can check an ELF file during the initialization process of a program in order to determine whether to perform selective mapping of the I-cache.

The data for selective mapping of the I-cache can, for example, be stored as part of the “process descriptor,” as will be known to those skilled in the art.

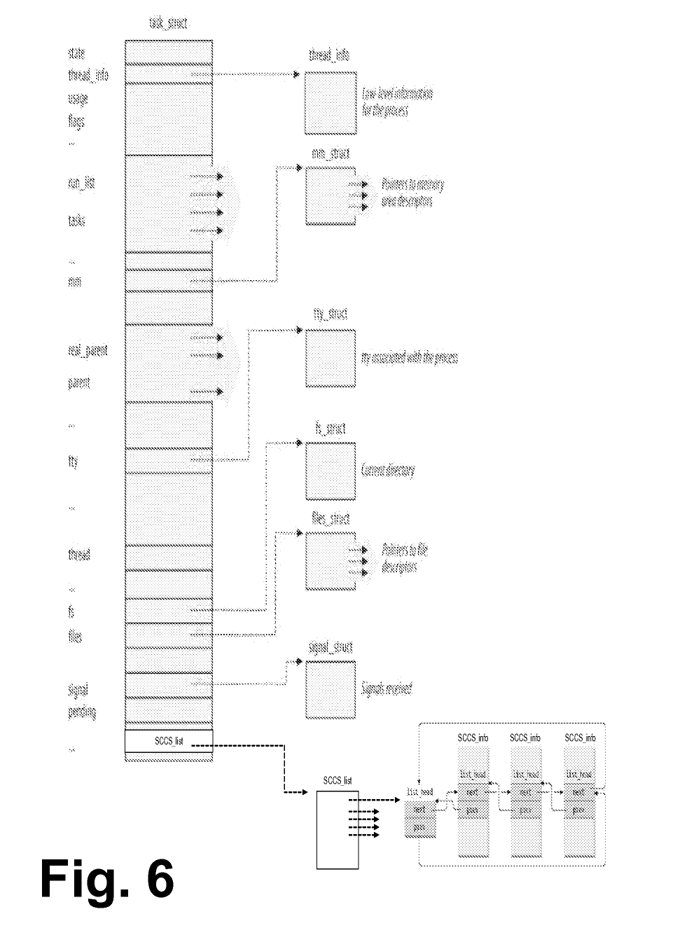

To further elaborate, FIG. 6 depicts an exemplary “process descriptor” in accordance with one embodiment of the invention. Generally, if a process requires a I-cache mapping feature, an indication can be made in a “process descriptor” of the process. For example, the “flags” field of the “process descriptor” can have a flag indicating a selective/enabling a selective I-cache mapping option. If the process requires selective I-cache mapping, the corresponding bit in “flags” field can be set to one (1), otherwise it can be set to zero (0). As another example, an indicator can be stored in “thread_info” even defining different process states where selective I-cache mapping is performed based on the current state of the process for.

If a process requires selective I-cache mapping, information pertaining to the security critical code sections (SCCS) can also stored in the “process descriptor” for the process. For example, “task_struct” can be expanded to define a new pointer (“SCCS_list”) for it. This pointer can be either NULL (if it is a regular process), or points to a SCCS_list vector (if selective I-cache mapping is needed). The details of each security critical code section can be stored in “SCCS_info” data structure. This data structure can also include “list_head structure” (defined and used in Linux), which allows them to be stored in doubly linked lists. Each doubly linked list can contain the “SCCS_info” of the code sections that are counterparts. For example, the details of the code sections 1 and 2 in the above example can be placed in the same doubly linked list, which will have only these two “SCCS_info” structures. The “SCCS_list” vector can holds the pointers to each of these doubly linked lists.

It should be noted that code sections, including code section that are mapped to the same section of an I-cache, can be selectively evicted, for example, in accordance with the techniques described by U.S. patent application Ser. No. (Atty Docket No. SISAP078/CSL08-TC10) entitled: “EVICTING CODE SECTIONS FROM SECONDARY MEMORY TO IMPROVE THE SECURITY OF COMPUTING SYSTEMS,” which is hereby incorporated by reference herein for all purposes.

Those skilled in the art will readily appreciate that the invention can be applied to multi-level caching systems. As such, the techniques discussed above can be readily applied to a third level cache, fourth level-cache, and so on.

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method of generating data for execution of executable computer code, wherein said computer-implemented method comprises:
obtaining, by a computing system, computer program code that includes a plurality of computer program code sections;
identifying, by said computing system, at least first and second computer program sections as sections to be effectively mapped to the same section of a secondary memory that serves as secondary memory with respect to a primary memory operable to store said executable computer code for execution by said computing system; and
generating, by said computing system, secondary-memory-mapping data that effectively identifies at least first and second computer code sections as sections to be mapped to the same section of said secondary memory when executable computer code for said first and second computer code sections is executed; and
storing, by said computing system, said secondary-memory-mapping data to a computer readable storage medium.

2. The computer-implemented method of claim 1, wherein said computer-implemented method further comprises: generating executable computer code for said computer program code including first and second executable computer code sections respectively for said first and second computer program code sections that said secondary-memory-mapping data is effectively provided and/or integrated with said executable computer code.

3. The computer-implemented method of claim 1, wherein said first and second computer program sections are effectively marked in said computer program code as sections to be mapped to the same section of a secondary memory.

4. The computer-implemented method of claim 1, wherein said computer-implemented method further comprises one or more of the following:
obtaining, by said computing system, sizes of said first and second executable computer code sections;
adding, by said computing system, one or more no-operations and/or dummy instructions to executable computer code of said first and/or second computer program sections to effectively cause executable code sections for said first and second computer program code to be the same size; and
effectively causing said first and second executable computer code sections to have the same size; and
effectively relocating, by said computing system, said first and/or second executable computer code sections when said executable computer code is stored in said primary memory, thereby effectively causing said first and/or second executable computer code; sections to be mapped to a section of said secondary memory and consequently stored to said section of said secondary memory when said computer system executes said executable computer program code.

5. A computer-implemented method of claim 1, wherein said computing system includes a compiler.

6. A computer-implemented method of claim 1,
wherein said secondary memory is operable to provide relatively faster access time than said primary memory but is smaller than said primary memory, and
wherein said secondary memory is an instruction cache and/or data cache provided for said primary memory.

7. The computer-implemented method of claim 1,
wherein said generating generates executable computer code is an Executable and Linking Format (ELF) and includes said secondary-memory-mapping data.

8. The computer-implemented method of claim 1, wherein said executable computer code is includes one or more of the following: object data, binary data, data in an Executable and Linking Format (ELF).

9. A computer-implemented method of storing executable computer code in a secondary memory that serves as secondary memory with respect to a primary memory operable to store said executable computer code for execution by a computing system, said computer-implemented method comprising:
storing executable computer code in said primary memory when said computing system is to execute said executable computer code, wherein said executable computer code includes a plurality of executable computer code sections;
identifying at least first and a second executable computer code sections of said plurality of executable computer code sections as sections to be mapped to the same section of said secondary memory; and
storing said first and a second executable computer code sections to said first section of said secondary memory when said computing system executes said executable computer code, wherein said secondary memory includes at least a plurality of discrete memory sections including said first section of said secondary memory, thereby storing said first and a second executable computer code sections to the same section of said secondary memory.

10. The computer-implemented method of claim 9, wherein said computer-implemented method further comprises:
obtaining, by said computing system, secondary-memory-mapping data that effectively identifying said at least first and a second executable computer code sections as sections to be mapped to the same section of said secondary memory.

11. The computer-implemented method of claim 9,
wherein said secondary memory is operable to provide relatively faster access time than said primary memory but is smaller than said primary memory, and
wherein said secondary memory is an instruction cache and/or data cache provided for said primary memory.

12. The computer-implemented method of claim 9, wherein said executable computer code also includes said secondary-memory-mapping data.

13. The computer-implemented method of claim 9, wherein said first and second executable computer code sections are of equal size.

14. The computer-implemented method of claim 4, wherein at least one of said first and a second executable computer code sections includes one or more no-operation and/or dummy instructions.

15. The computer-implemented method of claim 9, wherein said computer-implemented method further comprises:
obtaining, by a computing system, executable computer code including a plurality of executable computer code sections effectively identified as sections to be mapped to the same section of the said secondary memory.

16. A computing system, wherein said computing system is operable to:
obtain computer program code that includes a plurality of computer program code sections;
identify at least first and second computer program sections as sections to be effectively mapped to the same section of a secondary memory to be provided for a primary memory operable to store said executable computer code for execution by said computing system; and
generate secondary-memory-mapping data that effectively identifies at least first and a second executable computer code sections of said plurality of executable computer code sections as sections to be mapped to the same section of said secondary memory; and
storing said secondary-memory-mapping data to a computer readable storage medium.

17. The computing system of claim 16, wherein said computing system is further operable to generate executable computer code for said computer program code including first and second executable computer code sections respectively for said first and second computer program code sections such that said secondary-memory-mapping data is effectively provided and/or integrated with said executable computer code.

18. The computing system of claim 16, said computing system is further operable to perform one or more of the following:
obtain sizes of said first and second executable computer code sections;
add one or more no-operations and/or dummy instructions to executable computer code of said first and/or second computer program sections to effectively cause executable code sections for said first and second computer program code to be the same size; and
effectively cause said first and second executable computer code sections to have the same size; and
effectively relocate, by said computing system, said first and/or second executable computer code sections when said executable computer code is stored in said primary memory, thereby effectively causing said first and/or second executable computer code; sections to be mapped to a section of said secondary memory and consequently stored to said section of said secondary memory when said computer system executes said executable computer program code.

19. A computer readable storage medium in a tangible form and storing at least executable computer code embodied in a tangible form, wherein said computer readable storage medium includes:
executable computer code operable to obtain computer program code that includes a plurality of computer program code sections;
executable computer code operable to identifying at least first and second computer program sections as sections to be effectively mapped to the same section of a secondary memory to be provided for a primary memory operable to store said executable computer code for execution by said computing system; and
executable computer code operable to generate a secondary-memory-mapping data that effectively identifies at least first and a second executable computer code sections of said plurality of executable computer code sections as sections to be mapped to the same section of said secondary memory.

20. A computing system, wherein said computing system is operable to:
obtain computer program code that includes a plurality of computer program code sections;
identify at least first and second computer program sections as sections to be effectively mapped to the same section of a secondary memory that serves as secondary memory with respect to a primary memory operable to store said executable computer code for execution by said computing system; and
generate a secondary-memory-mapping data that effectively identifies at least first and a second executable computer code sections of said plurality of executable computer code sections as sections to be mapped to the same section of said secondary memory.

21. A computing system, wherein said computing system is operable to:
store executable computer code in primary memory when said computing system is to execute said executable computer code, wherein said executable computer code includes a plurality of executable computer code sections;
identifying at least first and a second executable computer code sections of said plurality of executable computer code sections as sections to be mapped to the same section of secondary memory during execution of said executable computer code; and
storing, by said computing system, said first and a second executable computer code sections to a first section of said secondary memory when said computing system executes said executable computer code, wherein said secondary memory includes at least a plurality of discrete memory sections including said first section of said secondary memory, thereby storing said first and a second executable computer code sections to the same section of said secondary memory.
